(19) United States
(12) Patent Application Publication
(10) Pub. No.: US 2001/0034971 A1
(43) Pub. Date: Nov. 1, 2001

(54) Divot retainer

(76) Inventors: Garrett Walsh, Dublin (IE); Russell Walsh, Dublin (IE)

Correspondence Address: JACOBSON, PRICE, HOLMAN & STERN, PROFESSIONAL LIMITED LIABILITY COMPANY, 400 SEVENTH STREET N.W., WASHINGTON, DC, 20004, US

(21) Appl. No.: 09/867,567

(22) Filed: May 31, 2001

Related U.S. Application Data
(63) Continuation of application No. PCT/IE99/00120, filed on Nov. 30, 1999.

(30) Foreign Application Priority Data
Dec. 1, 1998 (IE) S980994

(51) Int. Cl. A01G 29/00

(52) U.S. Cl. 47/48.5

(57) ABSTRACT

A divot retainer (1) has a flat rectangular divot retaining head (2) and a ground-penetrating stem (3) which is cross-shaped in plan. The retainer (1) is of a starch/plasticizer/water composition which is injection molded. It is stored until use in an air-tight package (10) and it is hydrophilic whereby it degrades upon contact with moisture. In appearance and mechanical strength it is plastics-like and degrades under the same conditions as is required by the divot knits back into the ground.

### FIELD OF THE INVENTION

The invention relates to divot retainers and to their production.

The problems caused by the taking of divots on golf courses are well known. In an effort to help replaced divots to knit back into the ground, it has been proposed to provide divot retainers. These have a stem or pin which is pressed down into the ground through the divot, and a head which engages the top of the divot. Penetration of the retainer into the ground secures the divot in place against removal by birds, wind or machinery for sufficient time for it to knit back.

PCT Patent Specification No. WO91/02171 describes such a retainer. It is stated that the material of the retainer may be peat or various other organic materials such as sawdust which may be pressed into shape, possibly with assistance of a binder. Uneted States Pantent Specification No. U.S. Pat. No. 5,211,722 also describes a divot retainer, and similar pressed organic materials are suggested. British Patent Specification No. 2046598 describes a divot retainer of clay composition and so the production technique would apparently again include pressing a particulate organic material. French Patent Specification No. 2648835 also describes a divot retainer, and it suggests a very broad set of biodegradable materials with little detail given. British Patent Specification No. 2298774 also describes a divot retainer, and it is stated in a general manner that the material is biodegradable. Likewise, British Patent Specification No. 2289848 describes a retainer and again little detail is given about the composition. British Patent Specification No. 1517890 also describes a divot retainer, again with little detail given about the composition.

### OBJECT OF THE INVENTION

The inventors are not aware of widescale use of divot retainers despite the clear requirement for them for golf course maintenance and the fact that they have been proposed in the literature for over twenty years. It appears that this is because the retainers of the prior art do not possess sufficient mechanical strength to penetrate hard ground while at the same time being biodegradable over a relatively short time. It also appears that the prior retainers are too expensive to produce in a commercially viable manner. The invention therefore addresses these problems.

### SUMMARY OF THE INVENTION

According to the invention, there is provided a divot retainer comprising a ground-penetrating stem and a divot-retaining head, characterised in that the retainer is of a molded starch-based hydrophilic composition.

In one embodiment, the composition comprises an organic starch and a plasticizer.

Preferably, the composition further comprises water. In one embodiment, the water proportion is in the range of 11.8% to 12.8% by weight.

In one embodiment, the composition comprises a dye of a natural starch-based resin with organic pigments. Preferably, the proportion of dye is approximately 2% by weight.

In one embodiment, the head is of elongate substantially rectangular shape in plan view.

In one embodiment, the stem is cross-shaped in plan. Preferably, the stem is symmetrical about both orthogonal axes.

According to another aspect, the invention provides a divot retainer contained in an air-tight package.

According to a still further aspect, the invention provides a method of producing a divot retainer comprising the steps of preparing a starch-based hydrophilic material and injection moulding the material to a form comprising an integral divot-retaining head and a ground-penetrating stem.

In one embodiment, the material comprises a destructured organic starch and a plasticizer.

In another embodiment, the material further comprises water.

Preferably, the relative proportions of starch, plasticizer, and water are approximately 83:5:12 by weight.

In one embodiment, a dye of a natural starch-based resin with organic pigments is added to the material before moulding.

Preferably, the proportion of dye is approximately 2% by weight.

In another embodiment, the material is dried by heating before moulding.

In a further embodiment, the material is dried by heating at a temperature in the range 95° C. to 105° C. for a duration of 1 to 2 hours

Preferably, the drying temperature is approximately 100° C. and the duration is approximately 90 minutes.

In one embodiment, the injection moulding barrel temperature is in the range of 185° C. to 215° C. Preferably, the barrel temperature is ramped up within said temperature range before injection, and preferably the temperature is ramped from approximately 190° C. to approximately 210° C.

In one embodiment, the barrel dwell time is in the range of 1 to 4 minutes and preferably is in the range of 2 to 3 minutes.

In one embodiment, the mold temperature is in the range of 9° C. to 30° C., and is preferably approximately 12° C.

In one embodiment, the material is simultaneously injected in a plurality of molds arranged in a ring-shaped configuration.

In one embodiment, the molds are water-cooled.

In one embodiment, the molds are shaped to provide a stem which is cross-shaped in plan.

In another embodiment, the material is injected into a mold open gate.

Preferably, the method comprises the further step of immediately packaging the retainer in an air-tight package.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a perspective view from above of a divot retainer of the invention;

FIG. 2 is a perspective view from the side of the retainer;

FIG. 3 is a perspective view of package of retainers;

FIGS. 4, 5, 6, and 7 are top plan, underneath plan, side elevation, and front elevation views respectively of the retainer;

FIG. 8 is a plan cross-sectional view of a stem of the retainer; and

FIGS. 9(a) to 9(d) are diagrammatic sketches illustrating use of the retainer.

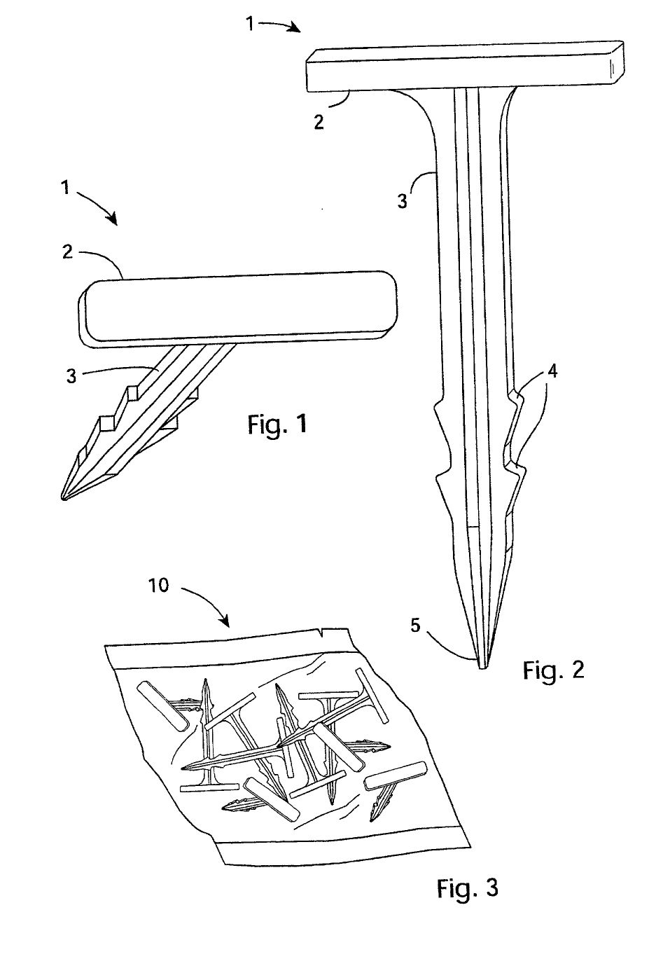

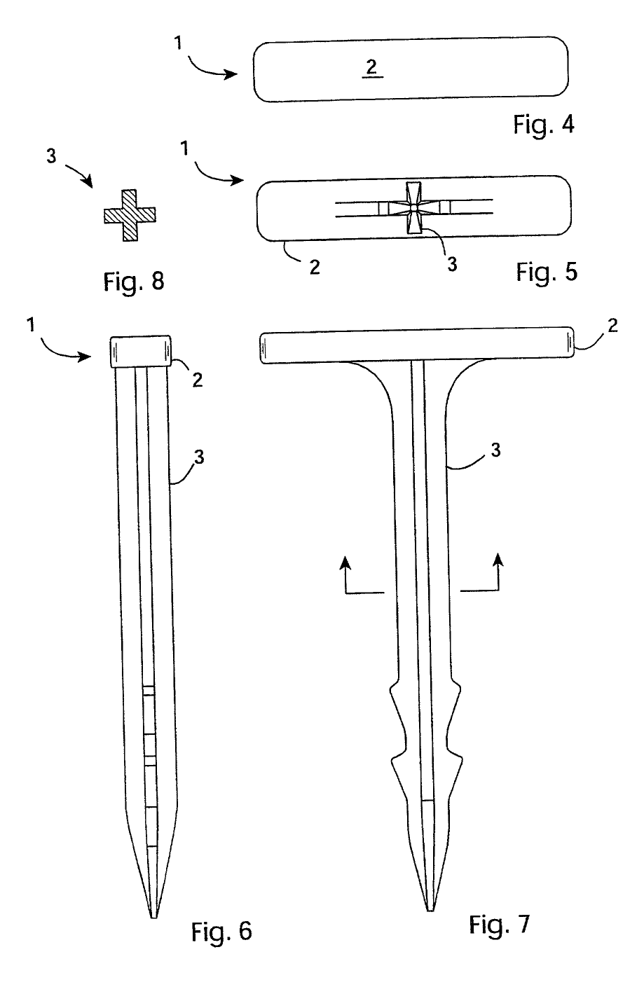

### DESCRIPTION OF THE EMBODIMENTS

Referring to the drawings, there is shown a divot retainer for use in replacing golf divots. The retainer 1 comprises a head 2 of a generally flat rectangular shape, which together with a stem 3 gives the retainer 1 an overall T-shape. The stem 3 comprises two pairs of opposed barbs 4 and it terminates at a pointed end 5. The stem 3 is symmetrically cross-shaped in plan, as shown most clearly in FIG. 8.

In appearance and strength, the retainer is plastics-like. It is distributed in a sealed plastics package 10 containing seven retainers. The package 10 is important for maintaining integrity of the retainers.

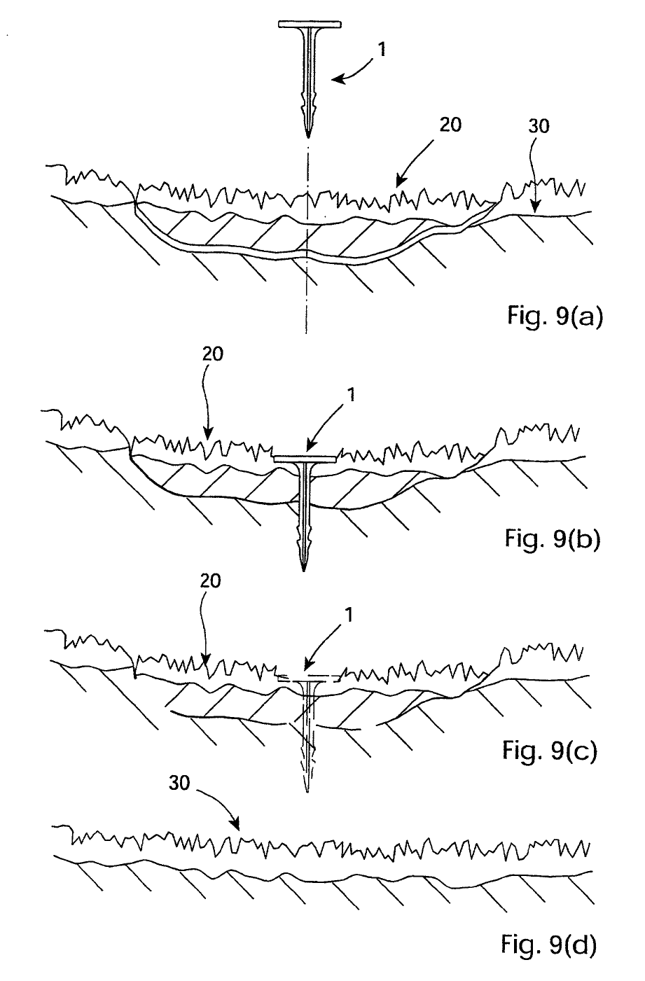

As illustrated in FIGS. 9(a) to 9(d), when a divot 20 is taken from ground 30, it is put back in place in the usual manner and a retainer 1 is used to pin it down. The head 3 provides excellent contact surface area to retain the divot 20 in position, while requiring relatively little material. The barbs 4 help to retain the retainer 1 in the ground. During the period illustrated in FIGS. 9(b) and 9(c) the retainer 1 very effectively prevents the divot 20 from being removed by wind, birds, or machinery. Also, while the retainer 1 is sufficiently strong to penetrate hard ground, it is not hard enough to damage machinery for cutting grass.

As illustrated in FIGS. 9(c) and 9(d), after a period of a couple of weeks the retainer 1 begins to degrade until it completely degrades at approximately the time when the divot 20 has knitted back into the ground 30.

The retainer 1 may be used in this manner both in soft ground and in hard ground, and irrespective of the type of soil involved. This is because the degradation is moisture-activated and is independent of the type of soil.

The composition of the retainer 1 is a hydrophilic material that absorbs moisture and degrades as a result. Thus, the same (moist) conditions are required both for degradation of the retainer and for sod regrowth. The time for degradation of the retainer 1 is such as to ensure that the sod is held in place long enough to knit back into the ground. It comprises organic starch which can be extracted from various plants such as potatoes, rice, tapioca, maize, and cereals such as rye, oats, wheat and the like. In more detail, the material comprises destructured starch, water, an organic plasticizer, and a dye.

This composition has the following environmentally-friendly properties:

(a) It can be recycled like conventional plastics.

(b) Can be disposed of same as organic domestic waste.

(c) Incineration is safe and does not yield toxic or metallic residue i.e. it “bums clean”.

It has been found that this material maintains its integrity while sealed in a container such as the thermally-sealed plastics sachet 10. It therefore has excellent mechanical strength provided it is removed from the sachet shortly before use. Indeed, it has been found that this materials system with a cross-shaped stem exhibits a Young's Modulus of 2000 MPa, equivalent to that of conventional plastics. The stem provides optimum strength and moisture-absorbing area for the quantity of material used.

The retainer 1 is produced by a moulding process. The starting material is destructured starch obtained by heating natural starch with a water content of 13% to 20% by weight in a sealed vessel to a temperature in the range 120° C. to 190° C. at a pressure corresponding to the vapour pressure of water at the used temperature. The melt is cooled and granulated to form destructured starch. The destructured starch is blended with an organic plasticizer glycerine to 5% by weight to improve the theological behaviour of the material in the process. The composition is then processed as follows.

(a) The composition is dried by heating in an oven for 90 minutes at 100° C. to reduce the water content to 12% by weight, This drying step is very important to the process because it results in considerably improving the strength of the molded retainer.

(b) A biodegradable dye is blended at a proportion of 2% by volume. The dye is a natural starch-based carrier resin with organic pigments.

(c) The heated blend of material is loaded into a moulding machine having a barrel temperature of 190° C.

(d) The material is heated to 210° C. in the barrel during a dwell time of less than 180 seconds, before being injected into the mold under pressure through a heated nozzle and through an open gate in the mold to optimise material flow. The cavities in the mold in which the parts are formed are arranged in a ring for two reasons. Firstly, to ensure similar injection pressure is achieved in all cavities, and secondly to maximise the number of cavities in the mold. Water is circulated throughout the mold to maintain it at 12° C. during the process. This ensures that the parts are cooled in the minimum time and parts eject easily from the mold as result of the small amount of shrinkage upon cooling. These design and operational characteristics result in more uniform parts. Also, it has been found that the cooling rate involved achieves excellent strength with minimal distortion.

(e) The molded retainers are immediately packed in the sachets 10 and the sachets are sealed.

It has been found that this process produces retainers having the mechanical and biodegradability properties set out above. The stem cross-sectional shape achieves a very high strength relative to the volume of material and it also allows very rapid cooling after moulding.

It will be appreciated that the invention provides a divot retainer which may be used easily to pin a divot down in both hard and soft ground. Also, it degrades upon contact with moisture and does not require good composting conditions in the ground as degradation is moisture activated. It therefore exhibits optimum biodegradability and mechanical strength properties for retaining divots until they knit back.

The invention is not limited to the embodiments described, but may be varied in construction and detail. For example, the pre-moulding drying could take place at a temperature in the range of 95° to 105° C. and there may be no temperature ramping in the barrel, although the latter is advantageous. The dwell time in the barrel may be up to 4 minutes although 2 to 3 minutes is preferred. The mold temperature may be in the range of 9° C. to 30° C., although c.12° C. is preferred. The dye could be included at a proportion in the range of 0.5% to 7% and the plasticizer may be within the range 0.5% to 9.0% by weight. The pre-moulding water content may be in the range 11.8% to 12.8% by weight. The starting material may be blended with additives such as polycaprolactone, poly(b-hydroxy butyrate)-co-(b-hydroxy valerate), derivitives of cellulose, polyvinyl alcohol, or polyester. Other organic plasticizers such as glycerol monoacetate, diacetate or triacetate, propylene gylcol, sorbitol, sodium diethylsulfosuccinate, triethyl citrate, trubutyl citrate could be used. While the retainer had been described for golf-course application, it may alternatively be used for any application requiring sods to knit back into the ground. An example, is landscape gardening. Also, the packaging material may be biodegradable.

The invention is not limited to the embodiments described, but may be varied in construction and detail within the scope of the claims.

1. A divot retainer comprising a ground-penetrating stem (3) and a divot-retaining head (2), characterised in that the retainer is of a molded starch-based hydrophilic composition.

2. A divot retainer as claimed in claim 1, wherein the composition comprises an organic starch and a plasticizer.

3. A divot retainer as claimed in claim 2, wherein the composition further comprises water.

4. A divot retainer as claimed in claim 2, wherein the water proportion is in the range of 11.8% to 12.8% by weight.

5. A divot retainer as claimed in claim 1, wherein the composition comprises a dye of a natural starch-based resin with organic pigments.

6. A divot retainer as claimed in claim 5, wherein the proportion of dye is approximately 2% by weight.

7. A divot retainer as claimed in claim 1, wherein the head is of elongate substantially rectangular shape in plan view.

8. A divot retainer as claimed in claim 1, wherein the stem is cross-shaped in plan.

9. A divot retainer as claimed in claim 8, wherein the stem is symmetrical about both orthogonal axes.

10. A divot retainer comprising a ground-penetrating stem (3) and a divot-retaining head (2), characterised in that the retainer is of a molded starch-based hydrophilic composition which comprises an organic starch, a plasticizer and water, and wherein the stem is cross-shaped in plan.

11. A divot retainer package comprising a divot retainer as claimed in claim 1 contained in an air-tight package.

12. A method of producing a divot retainer comprising the steps of preparing a starch-based hydrophilic material and injection moulding the material to a form comprising an integral divot-retaining head and a ground-penetrating stem.

13. A method as claimed in claim 12, wherein the material comprises a destructured organic starch and a plasticizer.

14. A method as claimed in claim 13, wherein the material further comprises water.

15. A method as claimed in claim 13, wherein the relative proportions of starch, plasticizer, and water are approximately 83:5:12 by weight.

16. A method as claimed in claim 12, wherein a dye of a natural starch-based resin with organic pigments is added to the material before moulding.

17. A method as claimed in claim 16, wherein the proportion of dye is approximately 2% by weight.

18. A method as claimed in claim 12, wherein the material is dried by heating before moulding.

19. A method as claimed in claim 18, wherein the material is dried by heating at a temperature in the range 95° C. to 105° C. for a duration of 1 to 2 hours.

20. A method as claimed in claim 19, wherein the drying temperature is approximately 100° C. and the duration is approximately 90 minutes.

21. A method as claimed in claim 12, wherein the injection moulding barrel temperature is in the range of 185° C. to 215° C.

22. A method as claimed in claim 21, wherein the barrel temperature is ramped up within said temperature range before injection.

23. A method as claimed in claim 22, wherein the temperature is ramped from approximately 190° C. to approximately 210° C.

24. A method as claimed in claim 23, wherein the barrel dwell time is in the range of 1 to 4 minutes.

25. A method as claimed in claim 24, wherein the barrel dwell time is in the range of 2 to 3 minutes.

26. A method as claimed in claim 12, wherein the mold temperature is in the range of 9° C. to 30° C.

27. A method as claimed in claim 26, wherein the mold temperature is approximately 12° C.

28. A method as claimed in claim 12, wherein the material is simultaneously injected in a plurality of molds arranged in a ring-shaped configuration.

29. A method as claimed in claim 28, wherein the molds are water-cooled.

30. A method as claimed in claim 12, wherein the molds are shaped to provide a stem which is cross-shaped in plan.

31. A method as claimed in claim 12, wherein the material is injected into a mold open gate.

32. A method as claimed in claim 12, wherein the method comprises the further step of immediately packaging the retainer in an air-tight package.

33. A method of producing a divot retainer comprising the steps of preparing a starch-based hydrophilic material, and injection moulding the material to a form comprising an integral divot-retaining head and a ground-penetrating stem, wherein said material comprises a destructured organic starch, plasticizer and water, and wherein said molds are shaped to provide a stem which is cross-shaped in plan.

34. A method of producing a divot retainer comprising the steps of preparing a starch-based hydrophilic material, and injection moulding the material to a form comprising an integral divot-retaining head and a ground-penetrating stem, wherein the material is dried by heating before moulding

35. A divot retainer whenever produced by a method as claimed in claim 12.
